(19) United States
(12) Patent Application Publication
(10) Pub. No.: US 2011/0069728 A1
(43) Pub. Date: Mar. 24, 2011

(54) Diode Pumped Ytterbium Doped Laser

(76) Inventor: Anthony Sebastian Bauco, Horseheads, NY (US)

(21) Appl. No.: 12/564,591

(22) Filed: Sep. 22, 2009

(51) Int. Cl. H01S 3/17; H01S 3/091

(52) U.S. Cl. 372/40; 372/71

(57) ABSTRACT

Diode pumped, ytterbium doped glass or glass ceramic lasers are provided. A laser source is provided comprising an optical pump, a glass or glass ceramic gain media, a wavelength conversion device, and an output filter. The gain media comprises a ytterbium doped glass or a ytterbium doped glass ceramic gain media and is characterized by an absorption spectrum comprising a maximum absorption peak and a sub-maximum absorption peak, each disposed along distinct wavelength portions of the absorption spectrum of the gain media. The optical pump and the gain media are configured such that the pump wavelength λ is more closely aligned with the sub-maximum absorption peak of the gain media than the maximum absorption peak of the gain media. Additional embodiments are disclosed and claimed.

### BACKGROUND

The present disclosure relates to frequency-converted laser sources and, more particularly, to diode pumped lasers configured for improved emission stability.

### BRIEF SUMMARY

Diode pumped, ytterbium doped glass or glass ceramic lasers are provided. In accordance with one embodiment of the present disclosure, a laser source is provided comprising an optical pump, a glass or glass ceramic gain media, a wavelength conversion device, and an output filter. The gain media comprises a ytterbium doped glass or a ytterbium doped glass ceramic gain media and is characterized by an absorption spectrum comprising a maximum absorption peak and a sub-maximum absorption peak, each disposed along distinct wavelength portions of the absorption spectrum of the gain media. The optical pump and the gain media are configured such that the pump wavelength λ is more closely aligned with the sub-maximum absorption peak of the gain media than the maximum absorption peak of the gain media.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIGS. 1 and 2 illustrates various aspects of different types of frequency-converted laser sources according to the present disclosure; and

FIG. 3 illustrates the absorption spectra of a gain media according to one embodiment of the present disclosure.

### DETAILED DESCRIPTION

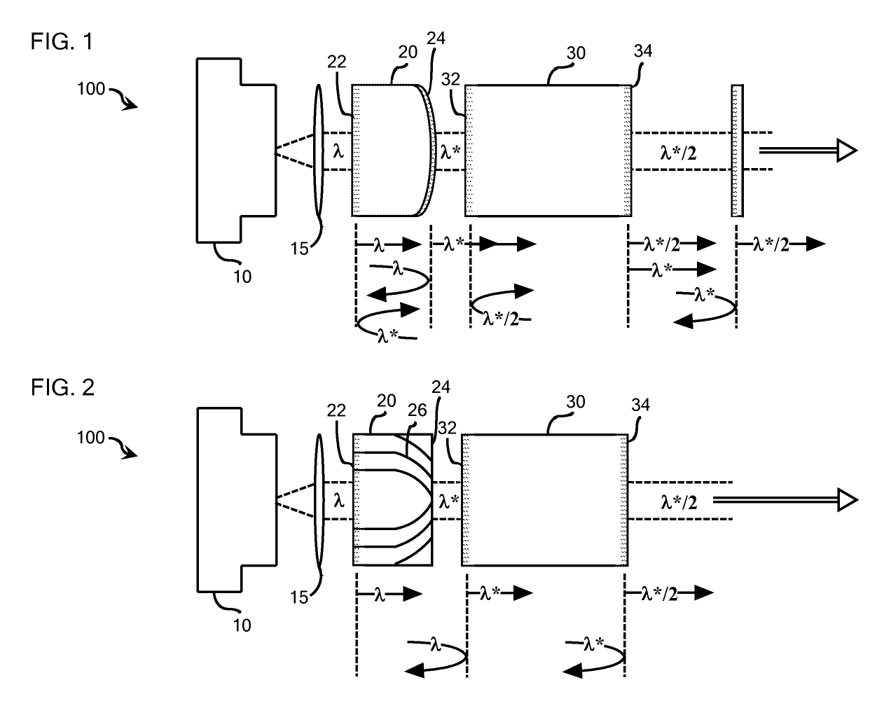

Referring initially to FIG. 1, an optically pumped laser source 100 is provided comprising an optical pump 10 configured to generate an optical pump beam characterized by a pump wavelength λ, coupling optics 15, a glass or glass ceramic gain media 20, a wavelength conversion device 30, and an output filter 40. As is illustrated in FIG. 1, the glass or glass ceramic gain media 20 is positioned upstream of the output filter 40 along an optical path extending downstream from the optical pump 10 to the output filter 40, which filter is typically configured as an external mirror with an integral IR filter but may merely comprise an output window or output aperture without any significant filtering characteristics.

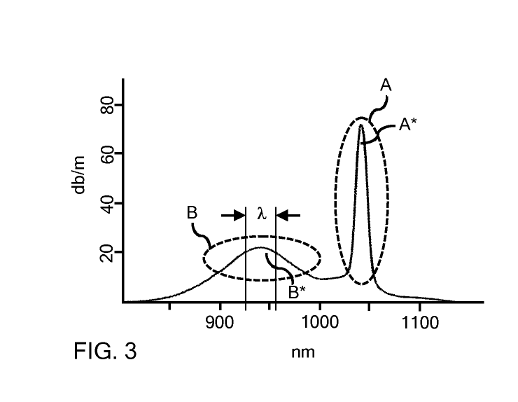

As is illustrated in FIG. 3, the gain media 20 comprises a ytterbium doped glass or a ytterbium doped glass ceramic gain media that is characterized by an absorption spectrum comprising a maximum absorption peak A and a sub-maximum absorption peak B, each disposed along distinct wavelength portions of the absorption spectrum of the gain media 20. The sub-maximum absorption peak B is illustrated in FIG. 3 as having a “near-peak” bandwidth B* of approximately 50 nm. In contrast, the maximum absorption peak A has a much narrower near-peak bandwidth A*, i.e., much less than 10 nm. In practicing various embodiments of the present disclosure, for reasons discussed in detail below, it is contemplated that the sub-maximum absorption peak B should define a near-peak bandwidth B* of at least approximately 20 nm, with the understanding that a “near-peak” bandwidth is understood to represent the bandwidth of the peak at approximately 5 dB/m less than the maximum optical absorption of the peak. It is noted that the aforementioned bandwidth values are presented herein to help quantify the difference between the maximum absorption peak A and the sub-maximum absorption peak B. The bandwidth values are introduced as a guide for implementing the concepts of the present disclosure and should not be interpreted as absolute representations, may vary from embodiment to embodiment, and will typically depend on a variety of parameters.

Although according to conventional practice, it would be counterintuitive to do so, the optical pump 10 and the gain media 20 are configured such that the pump wavelength λ is more closely aligned with the less efficient sub-maximum absorption peak B than the more spectrally efficient maximum absorption peak A. As a result, an optically pumped laser source 100 utilizing the gain media 20, which is configured for solid state optically pumped laser emission at a primary emission wavelength λ*, will be well-suited for stable operation over a wider range of operating temperatures because the near-peak absorption bandwidth B* of the sub-maximum absorption peak B is much broader than the near-peak absorption bandwidth A* of the maximum absorption peak A. The present inventors have recognized that this mode of operation is particularly well-suited for applications where the pump wavelength λ drifts significantly with operating temperature, as would be the case for less sophisticated, relatively inexpensive lasers. The present inventors have also recognized that any loss in efficiency attributable to alignment with the sub-maximum absorption peak B can be at least partially offset by efficiency gained by eliminating the need for sophisticated temperature stabilization schemes.

In particular embodiments of the present disclosure, the pump wavelength λ is selected such that it is confined to the near peak bandwidth B* of the sub-maxi mum absorption peak B over the entire operational wavelength drift of the optical pump. Alternatively, or additionally, the gain media 20 can be configured such that the near-peak bandwidth B* of the sub-maximum absorption peak B is larger than the operational wavelength drift of the optical pump 10. For the purposes of describing and defining the present invention, it is noted that the “operational wavelength drift” of the optical pump 10 covers the range over which the emission wavelength of the optical pump 10 drifts under normal operational use, excluding insignificant wavelength spikes or other wavelength departures that are not long enough in duration to be noticeable to the naked eye in a displayed image.

As will be appreciated by those familiar with the use of wavelength conversion devices in frequency-converted laser sources, the wavelength conversion device 30 is characterized by a QPM wavelength conversion bandwidth at which the primary emission wavelength λ* is converted to a frequency-converted output wavelength. In practicing concepts of the present disclosure, it is preferable to ensure that the primary emission wavelength λ* falls within the QPM bandwidth of the wavelength conversion device 30.

Although a variety of wavelength tuning and alignment scenarios will be suitable for practicing the concepts of the present disclosure, it is contemplated that the optical pump 10 and the gain media 20 can be configured such that the pump wavelength λ falls within the sub-maximum absorption peak B and outside of the maximum absorption peak A, as is illustrated in FIG. 3. More particularly, the pump wavelength λ can be confined to the near peak bandwidth B* of the sub-maximum absorption peak B. In other cases, it may be sufficient to ensure that the pump wavelength λ falls within 20 nm of the peak absorption of the sub-maximum absorption peak B. In other cases, it may be preferable to ensure that the near peak bandwidth B* of the sub-maximum absorption peak B is wide enough to accommodate a pump wavelength λ that varies by ±10 nm. Ytterbium doped glass and ytterbium doped glass ceramic gain media are particularly well-suited to meet these criteria, with the use of a suitable tunable or fixed wavelength laser diode optical pump 10. It is noted that the aforementioned wavelength values are presented herein to help quantify the pump wavelength λ. The wavelength values and ranges are introduced as a guide for implementing the concepts of the present disclosure and should not be interpreted as absolute representations, may vary from embodiment to embodiment, and will typically depend on a variety of parameters.

The input face 22 of the gain media 20, i.e., that which faces the optical pump 10, can be configured to be antireflective (AR) at the pump wavelength λ and highly reflective (HR) at the primary emission wavelength λ*. Preferably, although not essential to practicing concepts of the present disclosure, the reflectivity defines a narrow band matching the acceptance bandwidth of the wavelength conversion device 30.

The present inventor has recognized that ytterbium doped glass or glass ceramics are more suitable than crystals like YAG or Vanadate for providing the gain media with shaped surfaces because glass or glass ceramics are easier to grind or cast into non-flat shapes. Accordingly, it is contemplated that the output face 24 of the gain media can be configured in an aspheric shape, through suitable grinding or casting, to focus the primary emission beam at a selected focal point in the laser source 100. The present inventor has also recognized that ytterbium doped glass or glass ceramics are well suited for incorporating graded index profiles because dopants can be introduced as the glass is being deposited, such as during CVD (Chemical Vapor Deposition) operations. In contrast, it is unlikely that a graded index can be achieved in conventional crystal growth techniques. Accordingly, as is illustrated schematically in FIG. 2, the output region of the gain media can alternatively comprise a transverse graded index profile 26 to help focus the primary emission beam at a selected focal point in the laser source 100. In either case, the aspherical surface or graded index can be used to project a collimated beam from the optical pump 10 and focus it onto an external mirror located at the focal point of the lens formed by the gain media 20.

The present inventor has recognized that excess excited atoms tend to radiate spontaneously and do not generally contribute to the laser beam. In addition, the maximum power achieved in the fundamental laser mode of a laser cavity can be limited if there is an insufficient quantity of excited atoms near the optical axis of the laser limit the maximum power that can be achieved in the fundamental mode of the laser cavity. To address these operational challenges, it is contemplated that the dopant material can be introduced in a graded manner to match the dopant concentration to the laser cavity mode intensity profile. This type of dopant distribution can improve efficiency in the laser source because, in operation, more excited atoms will be near the axis of optical propagation, where the laser cavity mode intensity is typically the highest. One other beneficial side effect of this is that a graded dopant concentration gives strong preference to the fundamental laser cavity mode and helps keep the laser operating in a single spatial mode. This is desirable for applications where high spatial coherence is required, as is the case in laser scanning projectors.

Although the gain media 20 may take a variety of forms and define a variety of operating characteristics within the scope of the present disclosure, in the embodiment illustrated in FIG. 3 and in many other contemplated cases, the peak absorption of the sub-maximum absorption peak B will be at least approximately 30 db/m less than the peak absorption of the maximum absorption peak A. In addition, the near-peak bandwidth of the sub-maximum absorption peak B will typically be at least approximately three times larger than the near-peak bandwidth of the maximum absorption peak A. It is noted that the aforementioned absorption values are presented herein to help quantify the relative relationship between the maximum absorption peak A and the sub-maximum absorption peak B. The values are introduced as a guide for implementing the concepts of the present disclosure and should not be interpreted as absolute representations, may vary from embodiment to embodiment, and will typically depend on a variety of parameters.

For example, although the following quantities are estimates and will vary from case to case, it is contemplated that ytterbium doped glass and ytterbium doped glass ceramic gain media can be configured such that the peak absorption of the sub-maximum absorption peak B will be between approximately 20 db/m and approximately 70 db/m less than the peak absorption of the maximum absorption peak A, while the near-peak bandwidth B* of the sub-maximum absorption peak B is between approximately two and approximately twenty times larger than the near-peak bandwidth A* of the maximum absorption peak A. In further contemplated embodiments, the near-peak bandwidth B* of the sub-maximum absorption peak B will be greater than approximately 30 nm or between approximately 30 nm and approximately 60 nm.

In the illustrated embodiment, the pump wavelength λ is approximately 914 nm and the primary emission wavelength λ* is approximately 1030 nm. These particular wavelengths are advantageous on two counts. First, the relatively close proximity of the pump wavelength λ and the primary emission wavelength λ* represents relatively high pump absorption efficiency, particularly when compared to an optically pumped laser utilizing Nd doped gain media, which requires a pump wavelength of about 800 nm and an emission wavelength of about 1064 nm. Second, the frequency doubled wavelength of the 1030 nm emission is 515 nm, which is an excellent choice for projection displays because it results in better color depth.

In a broader sense, it is contemplated that the aforementioned advantages can be preserved by configuring the optical pump 10 and the gain media 20 such that the primary emission wavelength λ* is between approximately 1020 nm and approximately 1060 nm and the pump wavelength λ is above approximately 900 nm. More particularly, it is contemplated that the pump wavelength λ can be established between approximately 910 nm and approximately 925 nm while the primary emission wavelength λ* would be between approximately 1025 nm and approximately 1045 nm. In many cases, it will be useful to ensure that the primary emission wavelength λ* is no greater than approximately 200 nm longer than the pump wavelength λ to minimize energy lost in the gain media.

Optical efficiency can be further enhanced by ensuring that the output filter 40 is highly reflective or absorbing at the primary emission wavelength λ* and is anti-reflective at the frequency converted output wavelength λ*/2, as is illustrated in FIG. 1. Similarly, as is illustrated in FIG. 1, the input and output faces 32, 34 of the wavelength conversion device 30 can be configured to be anti-reflective at the primary emission wavelength λ*. Alternatively, as is illustrated in FIG. 2, the input face 32 of the wavelength conversion device 30 can be configured to be anti-reflective at the primary emission wavelength λ* while the output face 34 of the wavelength conversion device 30 is configured to be highly reflective at the primary emission wavelength λ*. In FIG. 2, the input face 32 of the wavelength conversion device 30 is configured to be antireflective at the primary emission wavelength λ* and highly reflective at the pump wavelength λ to recycle unabsorbed emissions from the optical pump 10. As will be appreciated by those practicing the concepts of the present disclosure, the input face 32 of the wavelength conversion device 30 can be AR or HR coated at the frequency converted output wavelength λ*12, depending on whether or not one wants to recycle frequency converted light or light at the primary emission wavelength λ* traveling upstream.

For the purposes of describing and defining the present invention, it is noted that an anti-reflective (AR) coating is configured for transmission of at least about 95% of the intensity of an optical signal at the specified wavelength. Similarly, a highly reflective (HR) coating is configured for reflection of at least about 95% of the intensity of an optical signal at the specified wavelength. The AR and HR components may be presented in a variety of forms, as one or more optical components. For example, the AR and HR components may comprise a dichroic mirror formed as a directly-deposited coating on an input or output face of a device.

Although not illustrated, it is contemplated that the laser source 100 may comprise one or more coupling lenses positioned along the optical path or may be optically coupled via conventional or yet-to-be developed proximity coupling techniques.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Rather, the claims appended hereto should be taken as the sole representation of the breadth of the present disclosure and the corresponding scope of the various inventions described herein.

Further, it will be apparent that modifications and variations are possible without departing from the scope of the invention defined in the appended claims. More specifically, although some aspects of the present disclosure are identified herein as preferred or particularly advantageous, it is contemplated that the present disclosure is not necessarily limited to these aspects. For example, although reference is frequently made herein to wavelength converted green lasers, where a second-order or higher order wavelength conversion device, e.g., a periodically poled lithium niobate (PPLN) SHG crystal, is used to convert a fundamental laser signal to a shorter wavelength signal, the various concepts of the present disclosure are not limited to lasers that operate in any particular part of the optical spectrum.

It is noted that recitations herein of a component of the present disclosure being “configured” in a particular way, to embody a particular property, or to function in a particular manner, are structural recitations, as opposed to recitations of intended use. More specifically, the references herein to the manner in which a component is “configured” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the present invention it is noted that the term “approximately” is utilized herein to represent the inherent degree of uncertainty that may be attributed to any quantitative comparison, value, measurement, or other representation. The term “approximately” is also utilized herein to represent the degree by which a quantitative representation may vary from a stated reference without resulting in a change in the basic function of the subject matter at issue.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

1. A laser source comprising an optical pump, a glass or glass ceramic gain media, a wavelength conversion device, and an output filter, wherein:
the optical pump is configured to generate an optical pump beam characterized by a pump wavelength λ;
the glass or glass ceramic gain media is positioned upstream of the output filter along an optical path extending downstream from the optical pump to the output filter;
the gain media comprises a ytterbium doped glass or a ytterbium doped glass ceramic gain media;
the gain media is characterized by an absorption spectrum comprising a maximum absorption peak and a sub-maximum absorption peak, each disposed along distinct wavelength portions of the absorption spectrum of the gain media;
the sub-maximum absorption peak is characterized by a near-peak bandwidth of at least approximately 20 nm;
the optical pump and the gain media are configured such that the pump wavelength λ is more closely aligned with the sub-maximum absorption peak of the gain media than the maximum absorption peak of the gain media;
the gain media, when optically pumped at the pump wavelength λ, is configured for solid state optically pumped laser emission at a primary emission wavelength λ* under optical pumping at the pump wavelength λ; and
the wavelength conversion device is characterized by a QPM wavelength conversion bandwidth at which the primary emission wavelength λ* is converted to a frequency-converted output wavelength; and
the primary emission wavelength λ* falls within the QPM bandwidth of the wavelength conversion device.

2. A laser source as claimed in claim 1 wherein the optical pump and the gain media are configured such that the pump wavelength λ is confined to the near peak bandwidth of the sub-maximum absorption peak.

3. A laser source as claimed in claim 1 wherein the optical pump and the gain media are configured such that the pump wavelength λ falls within 20 nm of the peak absorption of the sub-maximum absorption peak.

4. A laser source as claimed in claim 1 wherein the optical pump and the gain media are configured such that the near peak bandwidth of the sub-maximum absorption peak is wide enough to accommodate a pump wavelength λ that varies by ±10 nm.

5. A laser source as claimed in claim 1 wherein the gain media is configured such that:
the peak absorption of the sub-maximum absorption peak is at least approximately 30 db/m less than the peak absorption of the maximum absorption peak; and
the near-peak bandwidth of the sub-maximum absorption peak is at least approximately three times larger than the near-peak bandwidth of the maximum absorption peak.

6. A laser source as claimed in claim 1 wherein the gain media is configured such that:
the peak absorption of the sub-maximum absorption peak is between approximately 20 db/m and approximately 70 db/m less than the peak absorption of the maximum absorption peak; and
the near-peak bandwidth of the sub-maximum absorption peak is between approximately two and approximately twenty times larger than the near-peak bandwidth of the maximum absorption peak.

7. A laser source as claimed in claim 1 wherein the gain media is configured such that the near-peak bandwidth of the sub-maximum absorption peak is greater than approximately 30 nm.

8. A laser source as claimed in claim 1 wherein:
the optical pump is characterized by an operational wavelength drift; and
the optical pump and the gain media are configured such that the pump wavelength λ is confined to the near peak bandwidth of the sub-maximum absorption peak over the entire operational wavelength drift of the optical pump.

9. A laser source as claimed in claim 1 wherein the optical pump and the gain media are configured such that:
the optical pump is characterized by an operational wavelength drift; and
the near-peak bandwidth of the sub-maximum absorption peak is larger than the operational wavelength drift of the optical pump.

10. A laser source as claimed in claim 1 wherein the gain media is configured such that the primary emission wavelength λ* is between approximately 1020 nm and approximately 1060 nm.

11. A laser source as claimed in claim 1 wherein the optical pump and the gain media are configured such that the pump wavelength λ is above approximately 900 nm and the primary emission wavelength λ* is between approximately 1020 nm and approximately 1060 nm.

12. A laser source as claimed in claim 1 wherein the optical pump and the gain media are configured such that the pump wavelength λ is between approximately 910 nm and approximately 925 nm and the primary emission wavelength λ* is between approximately 1025 nm and approximately 1045 nm.

13. A laser source as claimed in claim 1 wherein the optical pump and the gain media are configured such that the primary emission wavelength λ* is no greater than approximately 200 nm longer than the pump wavelength λ to minimize energy lost in the gain media.

14. A laser source as claimed in claim 1 wherein:
an input face of the gain media facing the optical pump is configured to be antireflective at the pump wavelength λ and highly reflective at the primary emission wavelength λ*; and
an output face of the gain media is configured to be antireflective at the primary emission wavelength λ* and highly reflective at the pump wavelength λ to recycle unabsorbed emissions from the optical pump.

15. A laser source as claimed in claim 1 wherein an output face of the gain media is configured in an aspheric shape or comprises a transverse graded index profile to focus a primary emission beam at a selected focal point in the laser source.

16. A laser source as claimed in claim 1 wherein:
the output filter is configured to be highly reflective or absorbing at the primary emission wavelength λ* and anti-reflective at the frequency converted output wavelength; and
input and output faces of the wavelength conversion device are configured to be anti-reflective at the primary emission wavelength λ*.

17. A laser source as claimed in claim 1 wherein:
an input face of the wavelength conversion device is configured to be anti-reflective at the primary emission wavelength λ*; and
an output face of the wavelength conversion device is configured to be highly reflective at the primary emission wavelength λ*.

18. (canceled)

19. A laser source as claimed in claim 1 wherein the gain media comprises a dopant profile that approximates a mode intensity profile of the laser cavity.

20. A laser source comprising an optical pump, a glass or glass ceramic gain media, a wavelength conversion device, and an output filter, wherein:
the optical pump is configured to generate an optical pump beam characterized by a pump wavelength λ between approximately 910 nm and approximately 925 nm;
the glass or glass ceramic gain media is positioned upstream of the output filter along an optical path extending downstream from the optical pump to the output filter;
the gain media comprises a ytterbium doped glass or a ytterbium doped glass ceramic gain media;
the gain media is characterized by an absorption spectrum comprising a maximum absorption peak and a sub-maximum absorption peak, each disposed along distinct wavelength portions of the absorption spectrum of the gain media;
the peak absorption of the sub-maximum absorption peak is at least approximately 30 db/m less than the peak absorption of the maximum absorption peak;
the near-peak bandwidth of the sub-maximum absorption peak is at least approximately three times larger than the near-peak bandwidth of the maximum absorption peak;
the optical pump and the gain media are configured such that the pump wavelength λ is confined to the near peak bandwidth of the sub-maximum absorption peak;
the gain media, when optically pumped at the pump wavelength λ, is configured for solid state optically pumped laser emission at a primary emission wavelength λ* between approximately 1025 nm and approximately 1045 nm and no greater than approximately 200 nm longer than the pump wavelength λ;
an output face of the gain media is configured in an aspheric shape comprises a transverse graded index profile that functions to focus a primary emission beam at a selected focal point in the laser source;
the wavelength conversion device is characterized by a QPM wavelength conversion bandwidth at which the primary emission wavelength λ* is converted to a frequency-converted output wavelength; and
the primary emission wavelength λ* falls within the QPM bandwidth of the wavelength conversion device.

21. A laser source comprising an optical pump, a glass or glass ceramic gain media, and a wavelength conversion device, wherein:
the optical pump is configured to generate an optical pump beam characterized by a pump wavelength λ;
the glass or glass ceramic gain media is positioned upstream of the wavelength conversion device along an optical path extending downstream from the optical pump;
the gain media comprises a ytterbium doped glass or a ytterbium doped glass ceramic gain media;
the gain media is characterized by an absorption spectrum comprising a maximum absorption peak and a sub-maximum absorption peak, each disposed along distinct wavelength portions of the absorption spectrum of the gain media;
the sub-maximum absorption peak is characterized by a near-peak bandwidth of at least approximately 20 nm;
the optical pump and the gain media are configured such that the pump wavelength λ is more closely aligned with the sub-maximum absorption peak of the gain media than the maximum absorption peak of the gain media;
the gain media, when optically pumped at the pump wavelength λ, is configured for solid state optically pumped laser emission at a primary emission wavelength λ* under optical pumping at the pump wavelength λ;
the wavelength conversion device is characterized by a QPM wavelength conversion bandwidth at which the primary emission wavelength λ* is converted to a frequency-converted output wavelength; and
the primary emission wavelength λ* falls within the QPM bandwidth of the wavelength conversion device.
